(19) United States
(12) Patent Application Publication
(10) Pub. No.: US 2007/0031323 A1
(43) Pub. Date: Feb. 8, 2007

(54) Method for preparing perovskite oxide nanopowder

(76) Inventors: Sunggi Baik, Pohang-si (KR); Songhak Yoon, Pohang-si (KR)

Correspondence Address: David A. Einhorn, Esq.;Anderson Kill & Olick, P.C., 1251 Avenue of the Americas, New York, NY, 10020, US

(21) Appl. No.: 11/490,723

(22) Filed: Jul. 20, 2006

(30) Foreign Application Priority Data
Aug. 4, 2005 (KR) 10-2005-0071365

(51) Int. Cl. C01G 25/02

(52) U.S. Cl. 423/594.12; 423/598

(57) ABSTRACT

A method for preparing a perovskite oxide nanopowder by way of applying an ultrasonic nebulizer provides a narrow size distribution of spherical particles with minimum particle aggregation.

### FIELD OF THE INVENTION

The present invention relates to a novel method for preparing a perovskite oxide nanopowder having a narrow size distribution of spherical particles with minimum particle aggregation.

### BACKGROUND OF THE INVENTION

A nano-sized perovskite oxide powder has been conventionally prepared by a solid state reaction, coprecipitation, hydrothermal synthesis, sol-gel, or sol-precipitation method. The solid state reaction in which more than 2 solid sources are pulverized, mixed, and reacted at a high temperature of more than 1,000° C. to obtain a nanopowder, has the problem of generating a large particle size of more than 1 μm having an irregular particle shape caused by strong cohesion between the particles.

The coprecipitation method involves a calcination step conducted at a much lower temperature than the solid state reaction, and it has the advantages that the size of the initial nucleus is several nanometers, and the size and shape of nanopowder particle can be controlled and the nanopowder product has a homogeneous composition and a high purity. Further, the method can be industrially applicable due to its simple and economic process. However, this method is not suitable for the production of monodispersed particles of less than 100 nm.

The hydrothermal synthesis method on the other hand, produces at a relatively low temperature, crystalline particles having a spherical particle shape and a narrow particle size distribution with a small average particle size. However, this method is not suitable for the synthesis of an oxide complex having a homogeneous composition due to undesirable inter particle interactions.

The sol-gel method is capable of providing a highly pure nanopowder having a homogeneous composition and a very fine particle-size, but the nanoparticle produced by this method is amorphous, which requires crystallization by conducting heat treatment such as calcination at a high temperature more than 800° C., leading to particle aggregation, particle size increase, and a high production cost.

Further, the sol-precipitation method does not require any additional process such as calcination because the particles are formed at a low temperature of less than 100° C., but this method is not suitable for the preparation of monodispersed nanoparticles due to particle aggregation caused by rapid reactions of the starting materials.

For example, a conventional sol-precipitation method using an alkoxide has been carried out by adding titanium isopropoxide (Ti(OCH(CH₃)₂)₄) diluted in an alcohol to barium hydroxide octahydrate (Ba(OH)₂.8H₂O) dissolved in water while stirring vigorously at 90-100° C. to obtain a hyperfine barium titanate nanopowder (see [S. S. Flaschen, “An Aqueous Synthesis of Barium Titanate”, Journal of the American Chemical Society, 1955; K. Kiss et al., “Ferroelectric of Ultrafine Particle Size: I, Synthesis of Titanate Powders of Ultrafine Particle Size”, Journal of the American Ceramic Society, 1996; and P. Pinceloup et al., “Evidence of a Dissolution-Precipitation Mechanism in Hydrothermal Synthesis of Barium Titanate Powders”, Journal of the European Ceramic Society, 1999]). However, in this method, the particle size of nanopowder can not be easily controlled and the prepared particles aggregate extensively because the hydrolysis and condensation reacting occur explosively when the barium hydroxide octahydrate (Ba(OH)₂.8H₂O) solution meets the titanium isopropoxide (Ti(OCH(CH₃)₂)₄) solution.

### SUMMARY OF THE INVENTION

Accordingly, it is an object of the present invention to provide a novel method for preparing a perovskite oxide nanopowder having a narrow size distribution of spherical particles and a minimized cohesion between particles, by way of using an ultrasonic nebulizer.

In accordance with the present invention, there is provided a method for the preparation of an oxide nanopowder of formula (I) having a perovskite structure which comprises the steps of:

1) stirring an aqueous solution of a hydroxide hydrate of metal A at a temperature ranging from 60 to 100° C.;

2) introducing an alcohol solution of an alkoxide of metal B by spraying the alcohol solution into the stirred aqueous solution using an ultrasonic nebulizer to induce the precipitation of product, which was aged under the reaction for a period of 0.5 to 2 hrs.; and

3) isolating the product crystals obtained in Step 2):
ABO₃ (I)

wherein,

A is one or more divalent metals selected from the group consisting of magnesium, calcium, strontium and barium; and

B is tetravalent Zr or Ti.

### BRIEF DESCRIPTION OF DRAWINGS

The above and other objects and features of the present invention will become apparent from the following description of the invention taken in conjunction with the following accompanying drawings, which respectively show:

FIG. 1: an apparatus for preparing a perovskite oxide nanopowder by way of using an ultrasonic nebulizer according to the present invention;

FIG. 2: a flow chart representing the process for preparing a perovskite oxide nanopowder according to the present invention;

FIGS. 3 to 5: powder X-ray diffraction scan, scanning electron microscopic (SEM) photograph and transmission electron microscopic (TEM) photograph of the barium-strontium titanate nanopowder prepared in Example 1, respectively;

FIG. 6: TEM photograph of the barium-strontium titanate nanopowder prepared in Example 2; and

FIG. 7: SEM photograph of the barium-strontium titanate nanopowder prepared in Example 3.

### BRIEF DESCRIPTION OF THE MARKINGS

1: Ultrasonic nebulizer nozzle

2: Inlet of nebulizing solution

3: Outlet of nebulized liquid droplets

4: Power supply unit of ultrasonic wave generating means

5: Condenser with cooling water

6: Inlet of cooling water

7: Outlet of cooling water

8: Thermocouple

9: Magnetic stirrer

10: Reactor

11: Aqueous solution of hydrate of divalent metal hydroxide

### DETAILED DESCRIPTION OF THE INVENTION

The present invention provides a method of preparing a perovskite oxide nanopowder having a narrow size distribution of spherical particles with minimum particle aggregation, by adopting an ultrasonic nebulizer during a sol-gel precipitation reaction of an aqueous solution of a divalent metal hydroxide hydrate with an alcohol solution of a tetravalent metal alkoxide.

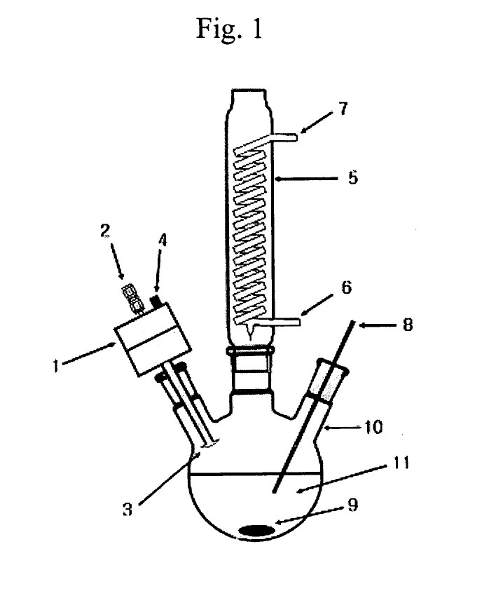

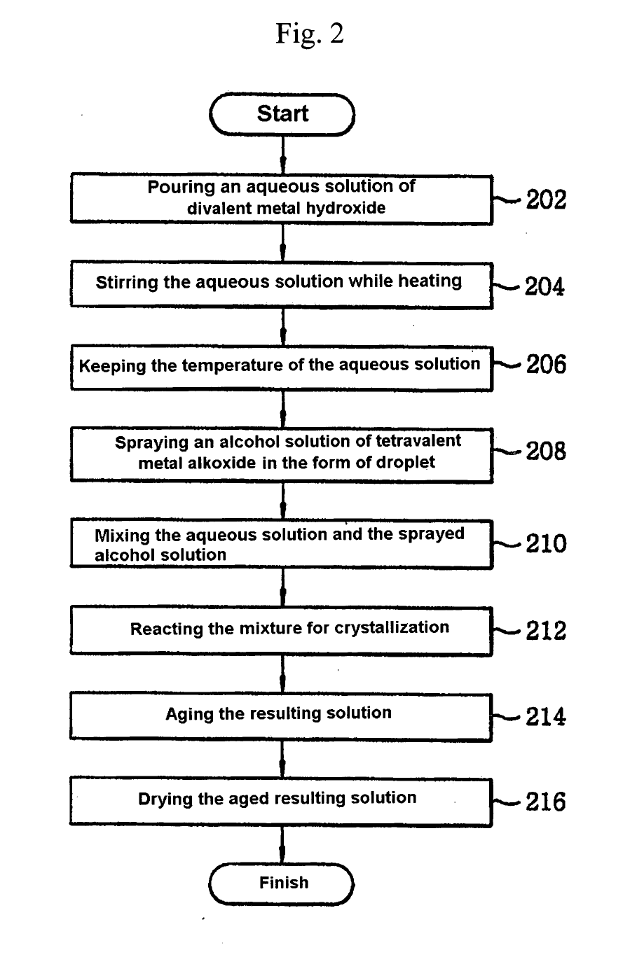

Referring to FIGS. 1 and 2, in the method for preparing a perovskite oxide nanopowder according to the present invention, an aqueous solution of a divalent metal hydroxide hydrate (11) prepared by dissolving a hydrate of a divalent metal hydroxide in water is poured into a reactor (10) (step 202). The preferred divalent metal is one or more metals selected form the group consisting of magnesium, calcium, strontium and barium, and the preferred hydrate of the divalent metal hydroxide is barium hydroxide octahydrate (Ba(OH)₂.8H₂O) and strontium hydroxide octahydrate (Sr(OH)₂.8H₂O).

Then, the aqueous solution (11) is stirred with a magnetic stirrer (9) while heating, e.g., at a rate 2° C./min (step 204). At this time, the temperature of the solution (11) is kept at a range of 60-100° C., preferably about 80° C. by checking the temperature with a thermocouple (8), and the solvent loss from the solution (11) is prevented by using a cooling water condenser (5) (step 206).

Then, an alcohol solution of a tetravalent metal alkoxide prepared by dissolving a tetravalent metal alkoxide in an alcohol is injected through an inlet (2) to be sprayed into the aqueous solution via an outlet (3) in the form of droplets having a uniform size ranging from 1 to 100 μm, preferably about 20 μm (step 208). The ultrasonic nebulizer nozzle (1) is equipped with an ultrasonic wave generating means connected to a power supply unit (4). The preferred tetravalent metal alkoxide is zirconium or titanium alkoxides selected from the group consisting of titanium or zirconium ethoxide, isopropoxide and butoxide; and the more preferred is titanium isopropoxide (Ti(OCH(CH₃)₂)₄). The alcohol is preferably selected from the group consisting of isopropanol, ethanol and butanol; and the more preferred alcohol is isopropanol.

As the alcohol solution is sprayed into the stirred aqueous solution, a rapid reaction takes place and the product becomes crystallized in the reactor (10) (steps 210 and 212). The precipitated crystals are then aged for 0.5 to 2 hours, preferably about 1 hour, filtered, and dried at a temperature lower than the reaction temperature for about 12 hours to obtain an oxide nanopowder (steps 214 and 216).

The inventive process of preparing the perovskite oxide nanopowder may be alternatively conducted by spraying both the aqueous solution (11) and the alcohol solution into the reactor simultaneously together.

In the present invention, the size of the perovskite oxide nanopowder can be easily controlled by adjusting the amount of the metal alkoxide in the alcohol solution of tetravalent metal alkoxide. The preferred is a solution prepared using 0.01 to 0.1 mole of tetravalent metal alkoxide and 2 to 20 moles of alcohol, and the most preferred are about 0.01 mole of a tetravalent metal alkoxide dissolved in about 5 moles of alcohol.

In contrast to the prior art methods, the present invention which exploits the use of an ultrasonic wave can provide a perovskite oxide nanopowder having a diameter of less than 100 nm, preferably 14 to 100 nm, a narrow size distribution of spherical particles and minimal inter particle cohesion. This inventive method does not require an additional dispersing step of the synthesized powder. Further, it can provide an oxide nanopowder having various types of perovskite structure and a diverse particle size in a large scale.

The following Examples are intended to further illustrate the present invention without limiting its scope.

### EXAMPLE 1

An aqueous solution of divalent metal hydroxide hydrate (11) was prepared by dissolving 0.006 mole of barium hydroxide octahydrate (Ba(OH)₂.8H₂O) and 0.004 mole of strontium hydroxide octahydrate (Sr(OH)₂.8H₂O) in 3 moles of doubly-distilled water at room temperature to obtain an aqueous barium hydroxide strontium solution. This solution was placed in a reactor (10), and heated to 80° C. at a rate 2° C./min over an oil bath on a hot plate which stirring with a magnetic stirrer (9).

Then, an alcohol solution of a tetravalent metal alkoxide was prepared by dissolving 0.01 mole of titanium isopropoxide (Ti(OCH(CH₃)₂)₄) in 5 moles of isopropanol at room temperature. The alcohol solution was introduced to the reactor through inlet (2) and sprayed into the stirred aqueous barium hydroxide and strontium hydroxide solution kept at 80° C., using the nebulizer nozzle (1), in the form of droplets having a uniform average size of about 20 μm (about 1 μm to 100 μm). As the aqueous solution (11) and the sprayed droplets of the alcohol solution were mixed, the product was crystallized and precipitated, which was aged under the reaction condition of 80° C. for 1 hr.

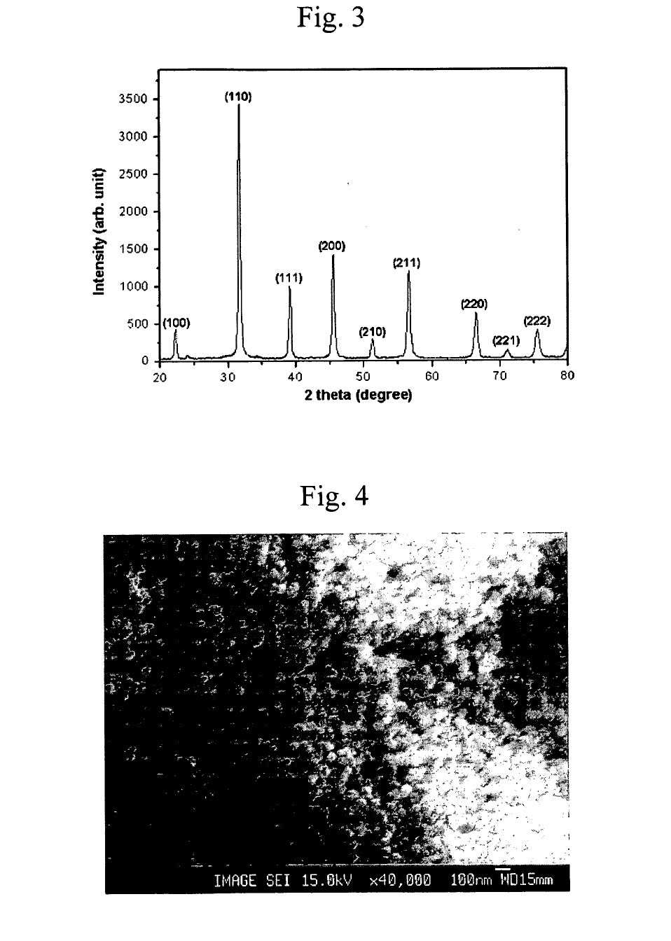

The precipitate was filtered and dried at 60° C. for about 12 hours to obtain a barium strontium titanate nanopowder. The nanopowder was analyzed by powder X-ray diffraction spectroscopy, scanning electron microscopy (SEM) and transmission electron microscopy (TEM), and the results are shown in FIGS. 3 to 5.

As can be seen in FIGS. 3 to 5, the obtained nanopowder is a spherical solid type nanopowder of barium-strontium titanate (Ba_{0.6}Sr_{0.4}TiO₃) of a perovskite structure having an average particle size of 40 nm, comprising 60 mole % of barium and 40 mole % of strontium.

### EXAMPLE 2

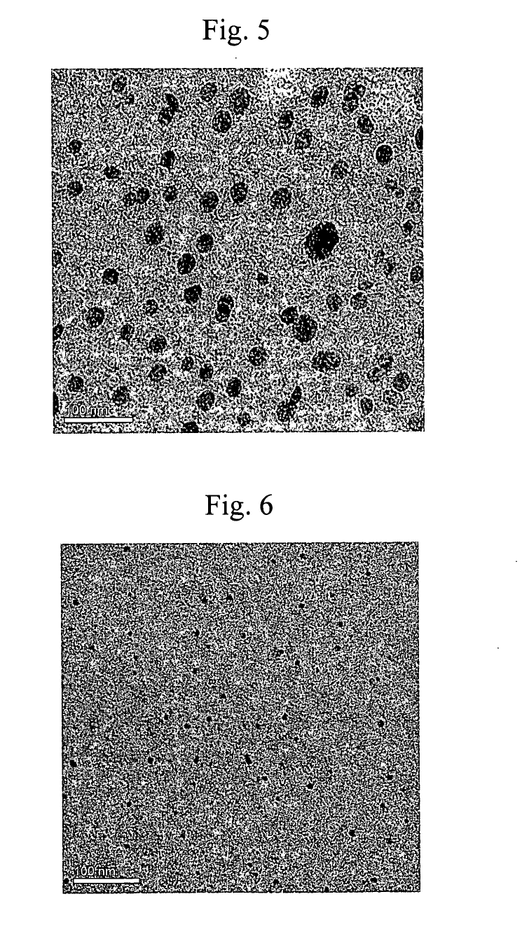

A spherical solid type nanopowder of barium-strontium titanate (Ba_{0.6}Sr_{0.4}TiO₃) of a perovskite structure having an average particle size of 14 nm was prepared by repeating the procedure of Example 1 except for using a tetravalent metal alkoxide alcohol solution prepared by diluting 0.01 mole of titanium isopropoxide in 15 moles of isopropanol at room temperature. The TEM image of the product is shown in FIG. 6.

### EXAMPLE 3

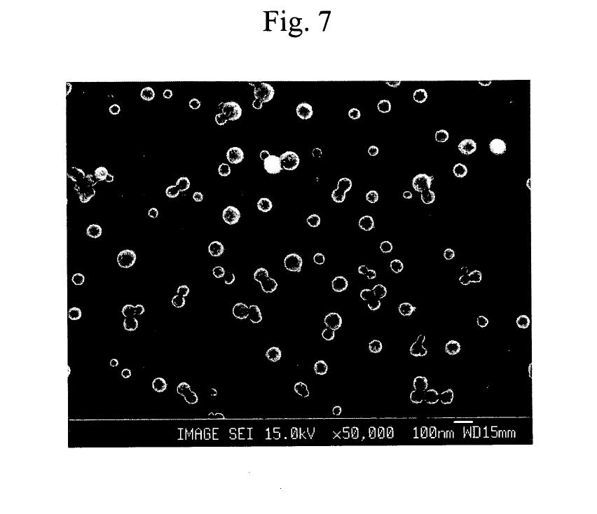

A spherical solid type nanopowder of barium-strontium titanate (Ba_{0.6}Sr_{0.4}TiO₃) of a perovskite structure having an average particle size of 70 nm was prepared by repeating the procedure of Example 1 except for using a tetravalent metal alkoxide alcohol solution prepared by diluting 0.01 mole of titanium isopropoxide in 2 moles of isopropanol at room temperature. The SEM image of the product is shown in FIG. 7.

While the invention has been described with respect to the above specific embodiments, it should be recognized that various modifications and changes may be made and also fall within the scope of the invention as defined by the claims that follow.

What is claimed is:

1. A method for the preparation of an oxide nanopowder of formula (I) having the perovskite structure which comprises the steps of:
1) stirring an aqueous solution of a hydroxide hydrate of metal A at a temperature ranging from 60 to 100° C.;
2) introducing an alcohol solution of an alkoxide of metal B by spraying the alcohol solution into the stirred aqueous solution using an ultrasonic nubulizer to induce the precipitation of product, which was aged under the reaction for a period of 0.5 to 2 hrs.; and
3) isolating the product crystals obtained in Step 2):
ABO₃ (I)
wherein,
A is one or more divalent metals selected from the group consisting of magnesium, calcium, strontium and barium; and
B is tetravalent Zr or Ti.

2. The method of claim 1, wherein the metal A hydroxide hydrate is barium hydroxide octahydrate (Ba(OH)₂.8H₂O) or strontium hydroxide octahydrate (Sr(OH)₂.8H₂O).

3. The method of claim 1, wherein the metal B alkoxide is zirconium or titanium ethoxide, isopropoxide or butoxide.

4. The method of claim 1, wherein the alcohol solution of the metal B alkoxide is prepared by dissolving 0.01 to 0.1 mole of the metal B alkoxide in 2 to 15 moles of an alcohol.

5. The method of claim 4, wherein the alcohol is selected from the group consisting of isopropanol, ethanol and butanol.

6. The method of claim 4, wherein the metal B alkoxide is titanium isopropoxide (Ti(OCH(CH₃)₂)₄) and the alcohol is isopropanol.

7. The method of claim 1, wherein in step (2), the alcohol solution of the metal B alkoxide is sprayed in the form of droplets having a size ranging from 1 to 100 μm.

8. The method of claim 1, wherein the oxide nanopowder product has an average diameter of less than 100 nm.
